(19) United States
(12) Patent Application Publication
(10) Pub. No.: US 2011/0016864 A1
(43) Pub. Date: Jan. 27, 2011

(54) ENERGY STORAGE SYSTEM

(75) Inventors: Sean Edward Wright, Arvada, CO (US); Richard Joseph Lordan, Cupertino, CA (US); Robert B. Schainker, Woodside, CA (US)

Correspondence Address: TREGO, HINES & LADENHEIM, PLLC, 9300 HARRIS CORNERS PARKWAY, SUITE 210, CHARLOTTE, NC, 28269-3797, US

(73) Assignee: ELECTRIC POWER RESEARCH INSTITUTE, INC., Palo Alto, CA (US)

(21) Appl. No.: 12/507,870

(22) Filed: Jul. 23, 2009

(51) Int. Cl. F02C 1/05; F02C 6/16

(52) U.S. Cl. 60/650; 60/652; 60/659; 60/684

(57) ABSTRACT

A compressed air energy storage (CAES) system encompassing direct heating. The compressed air energy storage system includes a compressor for compressing ambient air, an air storage reservoir, and a thermal energy storage system. The air storage reservoir is adapted to store compressed air from the compressor. The thermal energy storage system is adapted to supply heat to the compressed air energy storage system such that the compressed air is heated to increase work production of the compressed air. The thermal energy storage system is heated using off-peak electricity.

### BACKGROUND OF THE INVENTION

The present invention relates generally to an energy storage system, and more particularly to a compressed air energy storage (CAES) system encompassing direct heating. Electrical and/or mechanical power is used for both air compression, as well as heating of the expansion airflow through the use of a thermal energy storage (TES) system.

CAES systems dampen imbalances between power generation and power usage (act as generator or a load), as well as providing the capability of storing inexpensive or unwanted electrical power. CAES systems store this power through air compression. During power production the expanding air is heated to increase power production, to more efficiently use the stored air, and to avoid cryogenic expander requirements. Diabatic CAES systems rely on premium fuel combustion to achieve the required heating, either through individual combustors or combustion turbines.

Adiabatic or no-fuel CAES systems are becoming more attractive due to the high price of premium fuels (such as natural gas) and the need to reduce greenhouse gas emissions. The need for an energy storage mechanism with a low carbon footprint is particularly important for wind integration applications. Advanced diabatic CAES cycles generally include a combustion turbine and, as a result, cannot obtain or approach adiabatic or no-CO2 operation. It should be noted however, that advanced diabatic CAES systems can reduce relative NOₓ and CO₂ emissions in a broader perspective by facilitating full load or near-design operation of thermal power plants in the system.

The problems and disadvantages with various adiabatic approaches centers on the suitability and cost effectiveness of the various heat sources. For acceptable expansion temperatures and power production levels, a number of heat sources can only be used for supplemental or initial heating. These include heat pumps, geothermal sources and compression heat from standard industrial compressor trains. These sources are all limited to temperatures below about 500° F.

For example, geothermal sources are in the 200 to 400° F. range, with some geographical exceptions, compression heat from standard industrial compressor trains is in the range of 200 to 500° F., and high temperature industrial heat pumps are limited to temperatures of about 400° F. with a low temperature shift at this output temperature—meaning they cannot pump heat all the way from ambient temperature to 400° F. This is a result of refrigerant properties and fundamental thermodynamic limitations. In terms of performance, with a high output temperature, heat pumps fundamentally have a low coefficient of performance, typically less than 1.5 at 400° F.

Primary heating may be provided by sources such as solar thermal heating (750° F.) or high temperature compression trains currently under development (750 to 1200° F. design goals). Solar thermal systems are environmentally attractive but are relatively expensive. High temperature compression systems have a number of development issues. Conventional compressor development seeks to improve the efficiency primarily by reducing airflow temperatures. In contrast, high temperature compression CAES (HTCCAES) designs have the opposite goal, and high temperature operation and cycling leads to substantial thermal stress and durability issues that have not been adequately addressed.

### BRIEF SUMMARY OF THE INVENTION

These and other shortcomings of the prior art are addressed by the present invention, which provides a cost effective, direct heating adiabatic CAES system.

According to one aspect of the present invention, an energy storage system includes a compressor for compressing ambient air; an air storage reservoir adapted to store compressed air from the compressor; and a thermal energy storage system adapted to supply heat to the energy storage system such that the compressed air is heated to increase work production of the compressed air.

According to another aspect of the present invention, a compressed air energy storage system includes a compressor for compressing ambient air; an air storage reservoir adapted to store compressed air from the compressor; and a thermal energy storage system adapted to supply heat to the compressed air energy storage system such that the compressed air is heated to increase work production of the compressed air. The thermal energy storage system is heated using off-peak electricity.

### BRIEF DESCRIPTION OF THE DRAWINGS

The subject matter that is regarded as the invention may be best understood by reference to the following description taken in conjunction with the accompanying drawing figures in which:

FIG. 1 shows a direct heating CAES system according to an embodiment of the invention;

FIG. 2 shows a TES heating system according to an embodiment of the invention; and

FIG. 3 shows a direct heating CAES system according to an embodiment of the invention.

### DETAILED DESCRIPTION OF THE INVENTION

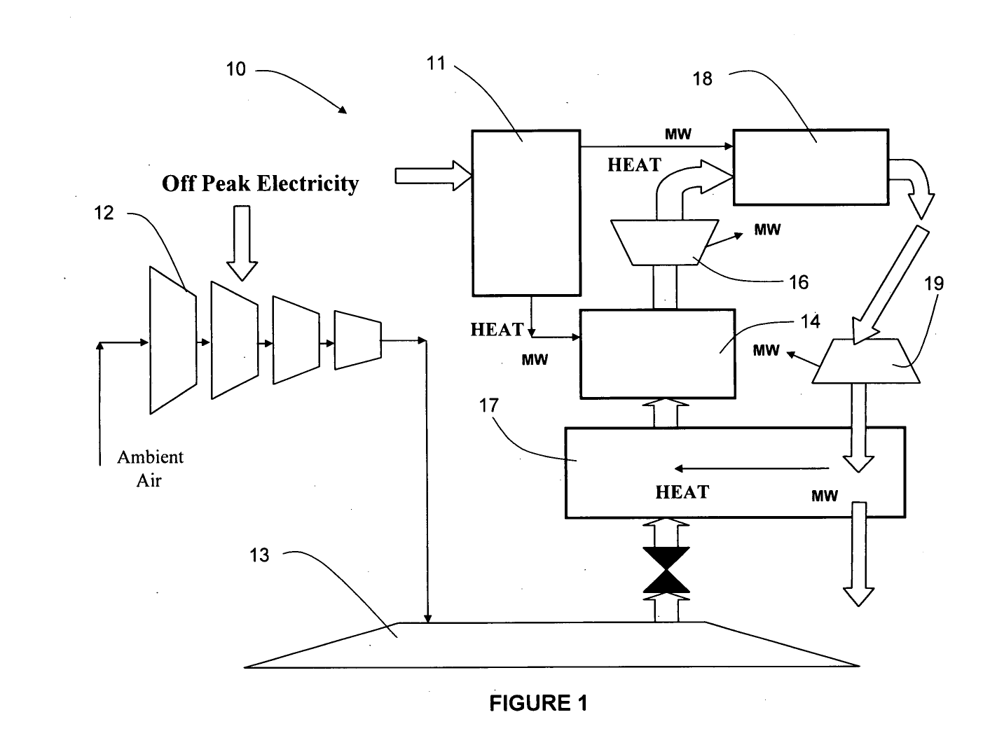

Referring to the drawings, an exemplary bulk energy storage system according to the present invention is illustrated in FIG. 1 and shown generally at reference numeral 10. The bulk energy storage system 10 is a compressed air energy storage (CAES) system that may be used in applications such as wind integration, arbitrage, load leveling, spinning reserve and ramping duty. The CAES system 10 attains a zero heat rate with direct heating of a thermal energy storage (TES) system 11 using off-peak, or any relatively low cost, electric power. Direct heating provides for high energy retention and efficiency compared to other heating options. Electric power is used for both air compression and heating of a TES material, such as molten salt, contained in the TES system 11. Supplemental heating of the TES material may also be obtained from other sources such as geothermal, solar thermal, and biomass sources with low or no net carbon dioxide emissions.

As shown, the CAES system 10 includes a compressor train 12 for compressing ambient air. The compressor train 12 is powered by off-peak electricity and compresses the ambient air to a desired operating and storage pressure. The compressed air is then stored in an air storage reservoir 13, such as an underground cavern. During periods of demand, the compressed air in the air storage reservoir 13 is released into the recuperator 17 where it is pre-heated. In order to increase efficiency, the recuperator 17 utilizes exhaust gas heat from the low pressure expander 19 to pre-heat the compressed air from the air storage reservoir 13 and to introduce the pre-heated compressed air to the high pressure heat exchanger 14.

The high pressure heat exchanger 14 receives heat from the TES system 11 to add heat to the pre-heated compressed air being received from the recuperator 17. The compressed air is then heated to a desired temperature by the high pressure heat exchanger 14 and sent to the high pressure expander 16 where the compressed air is expanded to produce work. The expanded air is then received by the low pressure heat exchanger 18 where additional heat is added to the expanded air. Like the high pressure heat exchanger 14, heat is provided to the low pressure heat exchanger 18 by the TES system 11.

The expanded air leaves the low pressure heat exchanger 18 and is received by the low pressure expander 19 where it is expanded to produce additional work. The exhaust gas from this process is then received by the recuperator 17 for pre-heating of the compressed air.

Operation of the system 10 requires that heat is supplied from the TES system 11 to at least one of the heat exchangers 14, 18, or both. The recuperator 17 is optional and is not necessarily required depending on operating conditions and other factors. The TES heat exchangers may alternatively be direct air flow systems.

The TES system 11 is heated using electrical power. The TES medium options include molten salts, thermal oils, ceramic beds and rock/pebble beds. Containment options include concrete structures, piping structures, spherical containment and tubular containment.

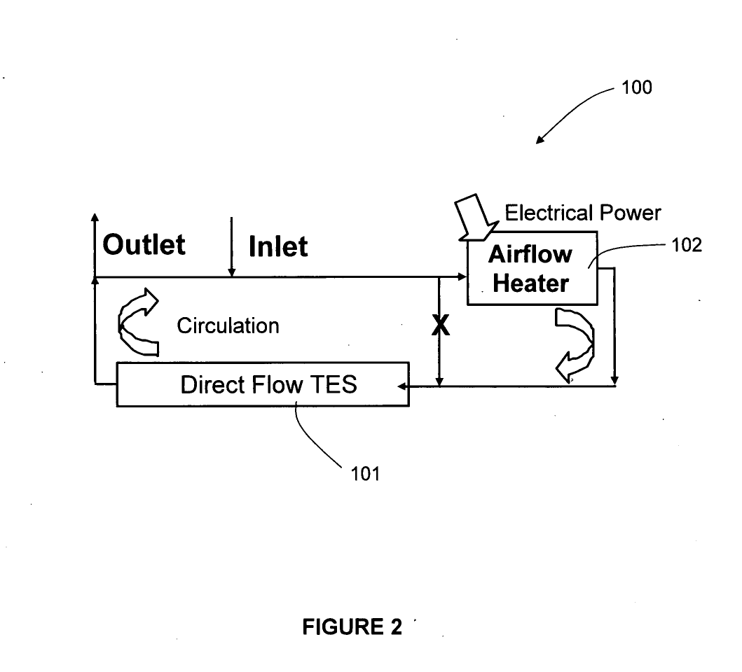

Referring to FIG. 2, a TES heating system according to an embodiment of the invention is shown generally at reference numeral 100. TES heating system 100 includes a containment structure 101 of tubular or other geometry, such as large diameter steel or other piping and contains a TES material such as a rock or ceramic type material. The containment structure 101 may be internally lined or insulated with material such as refractory bricks. Rather than internal or direct heating of the TES material, external heating may be provided using air flow heaters 102, such as screen and plasma heaters, thereby avoiding maintenance accessibility and reliability concerns for the heating elements. The TES heating system 100 may be heated to temperatures in excess of those required for expansion heating, greatly increasing thermal energy density, while allowing outlet air temperature to be controlled at a constant value during discharge. Further, the TES heating system 100 may operate at near ambient pressures during charging periods; thus, further reducing capital and operating costs.

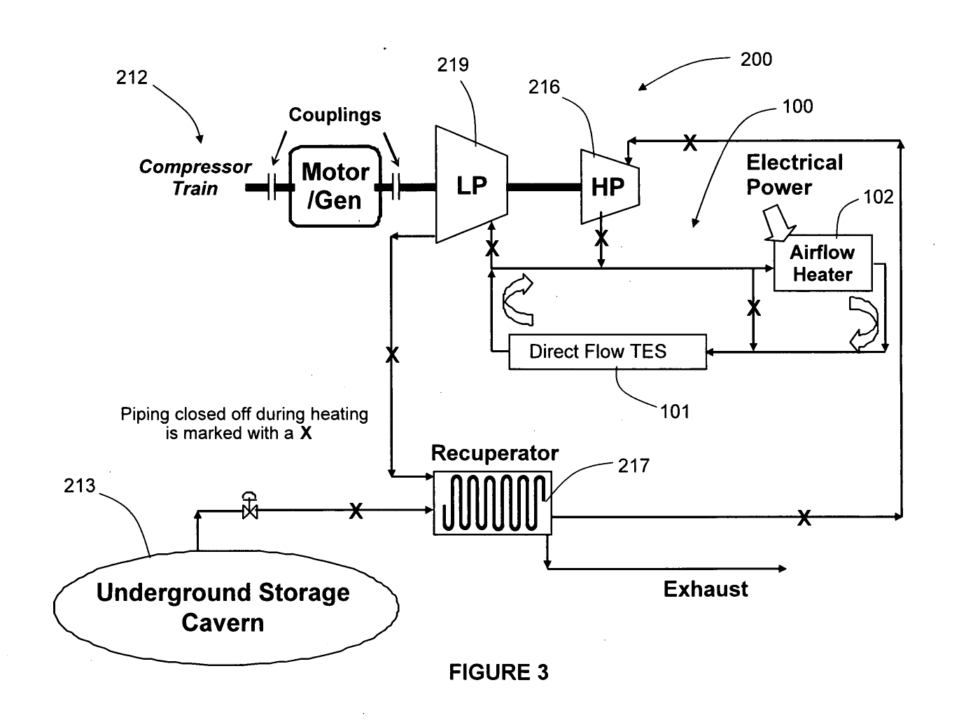

Referring to FIG. 3, a CAES system according to an embodiment of the invention is shown generally at reference numeral 200. Like the CAES system 10, the CAES system 200 includes a compressor train 212, an air storage reservoir 213, a high pressure expander 216, a recuperator 217, and a low pressure expander 219. The CAES system 200 incorporates the TES heating system 100 of FIG. 2 and allows a low pressure TES heat addition, with recuperation but with no high pressure TES heat addition. In this arrangement, the TES heating system 100 is thermally dense while operating at lower pressures than would be required for heating before the high pressure expander 216. The high pressure heat addition is eliminated along with its associated technical challenges and relatively high cost. The low pressure heat addition has relatively relaxed technical requirements. This TES and heating system may be operated alternatively for heat addition before high pressure expansion.

During charging, electrical power is used to run the airflow heaters 102 and to circulate air through the TES bed 101 to heat it. During TES discharging, heating of air from the air storage reservoir 213 during power production, inlet air directly enters the TES bed 101, while some of the flow may bypass the bed 101, mixing again before leaving the outlet of the TES system 100. This bypass allows the outlet temperature during discharging to be controlled even though the TES bed temperature varies over a wide range, in time and position along the bed 101. During TES charging, the TES material is to be heated to an arbitrarily high or material limited temperature above what is required for the expansion system to achieve high thermal energy storage density.

By using off-peak electric power for both air compression and direct heating of the TES material, the CAES systems 10, 200 are able to achieve adiabatic and no-CO₂ operation.

The CAES systems 10 and 200 described above provide a cost effective alternative to other CAES systems. Due to its simplicity, CAES system 10, 200 provide for a low capital cost, and low operational costs that depend primarily on the cost of the electrical power input. The cost of unwanted or off-peak electric power can be quite low, especially for wind integrated applications. For wind farms, this is particularly true of on-site CAES systems.

For example, a plant using the above CAES systems 10, 200, it is estimated that the plant would have an energy ratio of 2.00. Taking the input electricity price as $0.20/kWh, operating cost of $0.005/kWh, and an energy ratio of 2.00, the resulting on-peak electricity cost is estimated to be about 4.50¢/kWh. In addition, there are benefits associated with being a green operation. For example, there is no CO₂, CO or NOₓ production, no operating dependency on fuel cost—only a dependency on input electricity costs which will tend to drop as renewable penetration levels increase, or the plant is sited at a wind farm. Further, CAES systems 10, 200 do not require combustors, water injection and control systems, or selective catalytic reduction (SCR) systems for NOₓ removal.

The foregoing has described an energy storage system. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

We claim:

1. An energy storage system, comprising:
(a) a compressor for compressing ambient air;
(b) an air storage reservoir adapted to store compressed air from the compressor; and
(c) a thermal energy storage system adapted to supply heat to the energy storage system such that the compressed air is heated to increase work production of the compressed air.

2. The energy storage system according to claim 1, further including a low pressure expander adapted to expand the compressed air to produce work.

3. The energy storage system according to claim 1, further including a high pressure expander adapted to expand the compressed air to produce work.

4. The energy storage system according to claim 1, further including a recuperator adapted to receive compressed air from the air storage reservoir and pre-heat the compressed air.

5. The energy storage system according to claim 1, further including a high pressure heat exchanger adapted to receive heat from the thermal energy storage system and add heat to the compressed air.

6. The energy storage system according to claim 1, further including a low pressure heat exchanger adapted to receive heat from the thermal energy storage system and add heat to the compressed air.

7. The energy storage system according to claim 1, wherein off-peak electricity is used to provide direct heating to the thermal energy storage system.

8. The energy storage system according to claim 1, wherein the thermal energy storage system includes at least one airflow heater powered by off-peak electricity to provide heat to the thermal energy storage system.

9. The energy storage system according to claim 1, wherein the thermal energy storage system includes a bed of material selected from the group consisting of molten salts, thermal oils, ceramic beds, and rock or pebble beds.

10. A compressed air energy storage system, comprising:
(a) a compressor for compressing ambient air;
(b) an air storage reservoir adapted to store compressed air from the compressor; and
(c) a thermal energy storage system adapted to supply heat to the compressed air energy storage system such that the compressed air is heated to increase work production of the compressed air, wherein the thermal energy storage system is heated using off-peak electricity.

11. The compressed air energy storage system according to claim 10, further including:
(a) a recuperator adapted to receive compressed air from the air storage reservoir and pre-heat the compressed air;
(b) a high pressure expander adapted to receive the pre-heated compressed air from the recuperator and expand the compressed air to produce work; and
(c) a low pressure expander adapted to receive expanded compressed air from the high pressure expander and further expand the compressed air to produce work.

12. The compressed air energy storage system according to claim 11, wherein the recuperator receives at least a portion of the expanded compressed air from the low pressure expander to pre-heat the compressed air from the air storage reservoir.

13. The compressed air energy storage system according to claim 10, further including:
(a) a high pressure heat exchanger adapted to receive heat from the thermal energy storage system and add heat to compressed air from the air storage reservoir;
(b) a high pressure expander adapted to receive heated compressed air from the high pressure heat exchanger and expand the heated compressed air to produce work;
(c) a low pressure heat exchanger adapted to receive heat from the thermal energy storage system and add heat to the expanded compressed air from the high pressure expander; and
(d) a low pressure expander adapted to receive heated compressed air from the low pressure heat exchanger and further expand the heated compressed air to produce work.

14. The compressed air energy storage system according to claim 13, further including a recuperator for receiving compressed air from the air storage reservoir and pre-heating the compressed air prior to the compressed air being received by the high pressure heat exchanger.

15. The compressed air energy storage system according to claim 10, further including:
(a) a high pressure expander adapted to receive compressed air from the air storage reservoir and expand the compressed air, the expanded compressed air being delivered to the thermal energy storage system where the expanded compressed air is heated; and
(b) a low pressure expander adapted to receive heated compressed air from the thermal energy storage system and expand the heated compressed air to produce work.

16. The compressed air energy storage system according to claim 10, wherein the thermal energy storage system includes:
(a) a containment structure adapted to contain a thermal energy storage material; and
(b) at least one air flow heater adapted to provide heat to the thermal energy storage material.

17. The compressed air energy storage system according to claim 16, wherein the containment structure is internally lined or insulated with an insulating material.

18. The compressed air energy storage system according to claim 16, wherein the at least one air flow heater provides external heating to the thermal energy storage material.

19. The compressed air energy storage system according to claim 16, wherein the at least one air flow heater is selected from the group consisting of a screen heater, heating element, and a plasma heater.
